(19) United States
(12) Patent Application Publication
(10) Pub. No.: US 2026/0172109 A1
(43) Pub. Date: Jun. 18, 2026

(54) OPTICAL ADJUSTMENT TECHNIQUES IN FREE-SPACE OPTICAL COMMUNICATION SYSTEM

(71) Applicant: NEC Corporation, Tokyo (JP)

(72) Inventor: Hiroshi Imai, Tokyo (JP)

(73) Assignee: NEC Corporation, Tokyo (JP)

(21) Appl. No.: 19/405,687

(22) Filed: Dec. 2, 2025

(30) Foreign Application Priority Data
Dec. 17, 2024 (JP) 2024-220981

(51) Int. Cl. H04B 10/07; H04B 10/11; H04B 10/25

(52) U.S. Cl. CPC H04B 10/07; H04B 10/11; H04B 10/25

(57) ABSTRACT

An optical communication device includes a focus-adjustable optical system that focuses guide light having the same optical axis as signal light onto its focus position, thereby illuminating the light receiving surface over a wide range including a light reception area as a target area. A predetermined pattern is provided around the light reception area. When part of the predetermined pattern is illuminated by the guide light, a controller recognizes a partial pattern of the predetermined pattern from the image captured by a camera. Based on the partial pattern, the controller adjusts the focus-adjustable optical system so that the partial pattern matches a predetermined part of the predetermined pattern, allowing the signal light to be accurately directed to the light reception area.

### INCORPORATION BY REFERENCE

This application is based upon and claims the benefit of priority from Japanese Patent Application No. 2024-220981, filed on Dec. 17, 2024, the disclosure of which is incorporated herein in its entirety by reference.

### BACKGROUND

The present invention relates to optical adjustment techniques for accurately directing a light beam from a transmitter to a receiver.

### Background Art

For optical transmission of information through free space, the light emitted from a transmitter side needs to be accurately directed onto the light receiving surface of a receiver side. To adjust the size and position of an irradiation spot on the light receiving surface, many optical adjustment techniques for the irradiation spot have been proposed so far.

For example, according to a spatial optical communication system disclosed in Patent Document 1 (Japanese patent unexamined publication No. 2004-159032), a communication station transmits a transmission laser beam to the other station, monitors the intensity of laser light reflected from the other station, and adjusts the intensity, divergence angle, and emission direction of the transmission laser beam based on the monitored results.

### SUMMARY

However, in free-space optical communication between two spatially separated locations, it is extremely difficult to perform high-speed and high-accurate optical adjustment such as the divergence angle and emission direction of the transmission laser beam based on changes in received light intensity or distribution of received light intensity.

An object of the present invention is to provide a novel optical adjustment techniques that can perform optical adjustment in free-space optical communication at high speeds, with high precision, and with facility.

According to an aspect of the invention, an optical communication device that transmits signal light to another optical communication device in a free-space optical communication system, includes: an image capturing unit that captures an image including a predetermined pattern provided on a light receiving surface of the another optical communication device, wherein the predetermined pattern is provided around a light reception area which is a target area for the signal light; a focus-adjustable optical system configured to focus a light beam into a desired focus position between the optical communication device and the another optical communication device, wherein the light beam is one of guide light and the signal light which have a common optical axis; and a controller configured to: emit the guide light to the another optical communication device through the focus-adjustable optical system to illuminate a range wider than the light reception area with the guide light; extract a partial pattern of the predetermined pattern illuminated with the guide light from the image captured by the image capturing unit; and adjust at least one of the focus position and optical axis of the focus-adjustable optical system so that the partial pattern matches a predetermined part of the predetermined pattern causing the light reception area to be optimally illuminated with the signal light.

According to another aspect of the invention, an optical adjustment method in a free-space optical communication system in which signal light is transmitted from a transmitter to a receiver, includes: preparing a light receiving surface provided at the receiver, including a light reception area which is a target area for the signal light and a predetermined pattern provided around the light reception area; by a focus-adjustable optical system, focusing a light beam into a desired focus position between the transmitter and the receiver, wherein the light beam is one of guide light and the signal light which have a common optical axis; by a controller, emitting the guide light to the receiver through the focus-adjustable optical system to illuminate a range wider than the light reception area with the guide light; extracting a partial pattern of the predetermined pattern illuminated with the guide light from the image captured by an image capturing unit; and adjusting at least one of the focus position and optical axis of the focus-adjustable optical system so that the partial pattern matches a predetermined part of the predetermined pattern causing the light reception area to be optimally illuminated with the signal light.

According to still another aspect of the invention, a non-transitory recording medium storing a computer-readable program for a transmitter in a free-space optical communication system in which signal light is transmitted from the transmitter to a receiver, wherein the optical communication device includes: an image capturing unit that captures an image including a predetermined pattern provided on a light receiving surface of the receiver, wherein the predetermined pattern is provided around a light reception area which is a target area for the signal light; and a focus-adjustable optical system configured to focus a light beam into a desired focus position between the transmitter and the receiver, wherein the light beam is one of guide light and the signal light which have a common optical axis, the program includes instructions to: emit the guide light from a guide light source to the receiver through the focus-adjustable optical system to illuminate a range wider than the light reception area with the guide light; extract a partial pattern of the predetermined pattern illuminated with the guide light from the image captured by an image capturing unit; perform pattern matching of the partial pattern and the predetermined pattern; and adjust at least one of the focus position and optical axis of the focus-adjustable optical system so that the partial pattern illuminated matches a predetermined part of the predetermined pattern causing the light reception area to be optimally illuminated with the signal light.

According to the present invention, optical adjustment in free-space optical communication can be performed at high speeds, with high precision, and with facility.

### BRIEF DESCRIPTION OF THE DRAWINGS

FIG. 1 is a configuration diagram illustrating an example of an optical adjustment system according to an example embodiment of the present invention.

FIG. 2 is a schematic block diagram illustrating an example of a focus-adjustable lens unit in FIG. 1.

FIG. 3 is a diagram illustrating an example of a predetermined pattern in FIG. 1.

FIG. 4 is a schematic diagram illustrating an example of the optimum irradiation size and location of guide light in the predetermined pattern illustrated in FIG. 3.

FIG. 5 is a block diagram illustrating the configuration of a transmitter according to an example of the present invention.

FIG. 6 is a schematic diagram illustrating the focus deviation of the guide light based on the predetermined pattern as illustrated in FIG. 3.

FIG. 7 is a schematic diagram illustrating an axial deviation of the guide light based on the predetermined pattern as illustrated in FIG. 3.

FIG. 8 is a diagram illustrating coordinate axes generally representing the beam focus deviation and optical axis deviation for optical adjustment according to the present example.

FIG. 9 is a flowchart illustrating an optical adjustment method of the optical adjustment device according to the present example.

FIG. 10 is a block diagram illustrating an example of a transmitter in a quantum key distribution system to which the optical adjustment system according to the present example is applied.

### DETAILED DESCRIPTION

### Overview of Example Embodiments

According to an example embodiment of the present invention, a focus-adjustable optical system focuses guide light, which has the same optical axis as signal light, onto its focus position, thereby illuminating a light receiving surface over a wide range including a light reception area of the other party of communication. A predetermined pattern is provided around the light reception area. Accordingly, part of the predetermined pattern is illuminated by the guide light. The illuminated part is captured by a camera. The captured partial pattern of the predetermined pattern varies depending on a change of the focus position and/or optical axis of the focus-adjustable optical system. The focus-adjustable optical system is adjusted so that a partial pattern illuminated by the guide light matches a predetermined part of the predetermined pattern, by which the signal light having the same optical axis as the guide light is accurately directed to the light reception area on the light receiving surface of the receiver. In this way, high-speed and high-precise optical adjustment can be easily achieved.

Hereinafter, example embodiments of the present invention will be described in detail with reference to the drawings. However, the components described in the following example embodiments and examples are merely illustrative and are not intended to limit the technical scope of the present invention to those alone.

### 1. First Example Embodiment

### <System Configuration>

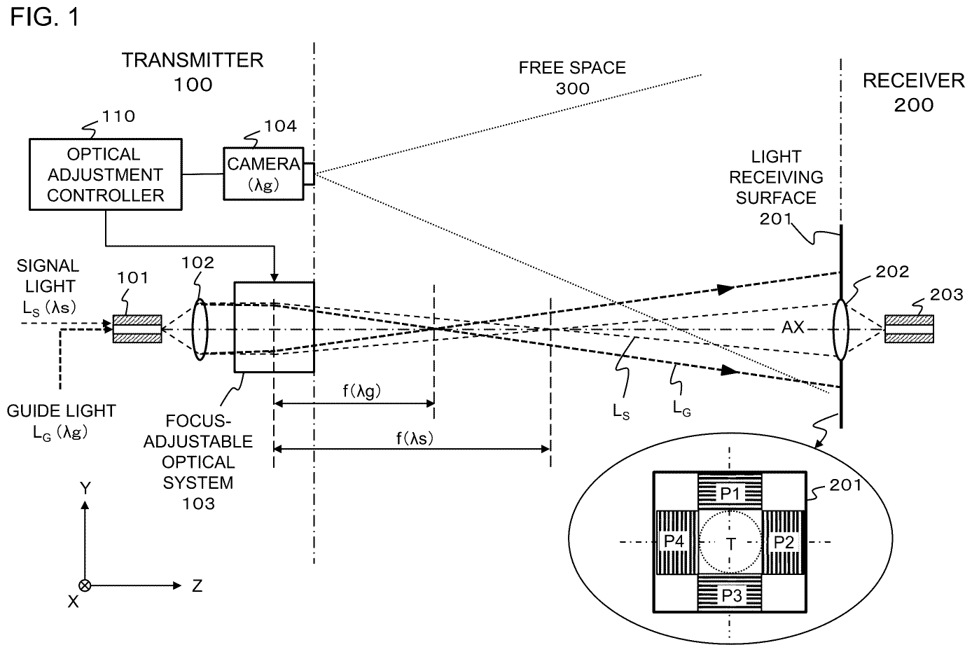

As illustrated in FIG. 1, an optical adjustment technique according to the present example embodiment is applied to a free-space optical communication system. The free-space optical communication system includes a transmitter 100 as an optical communication device and a receiver 200 as another optical communication device, which are optically connected via free space 300. Free space 300 is an unobstructed space for straight-line propagation of electromagnetic waves including light, regardless of whether it propagates in the atmosphere or in a vacuum. Hereinafter, the optical axis AX of the guide light L_{G} and signal light L_{S} in the transmitter 100 is represented by Z axis, and the plane perpendicular to the optical axis AX is represented by X axis and Y axis.

The transmitter 100 includes an optical fiber 101, a collimator 102, a focus-adjustable optical system 103, a camera 104, and an optical adjustment controller 110. The optical fiber 101, the collimator 102, and the focus-adjustable optical system 103 are arranged on the same optical axis. The guide light L_{G} or signal light L_{S} emitted from the optical fiber 101 is collimated by the collimator 102 to enter the focus-adjustable optical system 103. In the present example embodiment, the wavelength of the guide light L_{G} is λg, and the wavelength of the signal light L_{S} is λs, where the wavelength λg is shorter than the wavelength λs (λg<λs).

The focus-adjustable optical system 103 is a focusing optical system that includes optical elements having refractive surfaces. The focus-adjustable optical system 103 can make an incident collimated light beam form a beam waist at the focus position between the focus-adjustable optical system 103 and the receiver 200, thereby illuminating the light receiving surface 201 of the receiver 200.

As is well known, the refractive index increases as the wavelength shortens. Accordingly, the focal length f(λg) for the guide light L_{G} is shorter than the focal length f(λs) for the signal light L_{S}, resulting in the guide light L_{G} illuminating the light receiving surface 201 with a beam diameter larger than that of the signal light L_{S}. Since the guide light L_{G} and the signal light L_{S} have a common optical axis, the illumination range and position of the signal light L_{S} can be determined by detecting the illuminated range and position by the guide light L_{G} on the light receiving surface 201. In other words, the focal deviation and optical axis deviation of the signal light L_{S} can be detected from the illuminated range and position by the guide light L_{G}.

A collimator 202 is provided at a predetermined position on the light receiving surface 201. The aperture of the collimator 202 serves as a light reception area (target area) T for the signal light L_{S}. When the light reception area T at the predetermined position is illuminated with the signal light L_{S} of a designated beam diameter arriving from the transmitter 100 along the optical axis AX, the collimator 202 focuses the received signal light L_{S} into the receiving end of the optical fiber 203.

On the light receiving surface 201, a predetermined pattern (P1-P4) is arranged around the light reception area T by printing, sticking, or similar methods. Since the guide light L_{G} has a beam diameter larger than the signal light L_{S} on the light receiving surface 201, it is possible to illuminate not only the light reception area T but also a part of the predetermined pattern (P1-P4) around the light reception area T.

The predetermined pattern (P1-P4) is composed of multiple reflective areas radially spreading out from the center of the light reception area T. It is preferable that each reflective area is made of reflective material (retroreflective material) that reflect the incident light for each reflective area. The predetermined pattern (P1-P4) can be any pattern capable of detecting the range and position illuminated with the guide light L_{G}. For example, the predetermined pattern may have a configuration in which multiple reflective areas are arranged along the X-axis and Y-axis directions, respectively. Specific examples of the predetermined pattern will be described later.

The camera 104 provided in the transmitter 100 is an imaging device (two-dimensional sensor) that selectively receives light of wavelength λg, and is capable of capturing a wide area including the light receiving surface 201 of the receiver 200. Accordingly, the camera 104 can acquire an image of the light receiving surface 201 illuminated with the guide light L_{G} of wavelength λg, that is, a part of the predetermined pattern (P1-P4), which is hereinafter referred to as a partial pattern. Accordingly, a partial pattern can be obtained without aligning the camera 104 with the optical axis of the collimator 202.

The optical adjustment controller 110 inputs the image captured by the camera 104 and, as described later, can identify which part of the predetermined pattern (P1-P4) a partial pattern corresponds to by using techniques such as pattern recognition. Accordingly, the optical adjustment controller 110 can match the captured partial pattern to a center portion of the predetermined pattern (P1 to P4) centered around the light reception area T by adjusting the focus position and/or optical axis position of the focus-adjustable optical system 103. In other words, by matching the partial pattern imaged by the illumination of the guide light L_{G} with the center portion of the predetermined pattern, the light reception area T can be accurately illuminated with the signal light L_{S} having the same optical axis as the guide light L_{G}. Details will be provided below regarding the focus-adjustable optical system 103.

### <Focus-Adjustable Optical System>

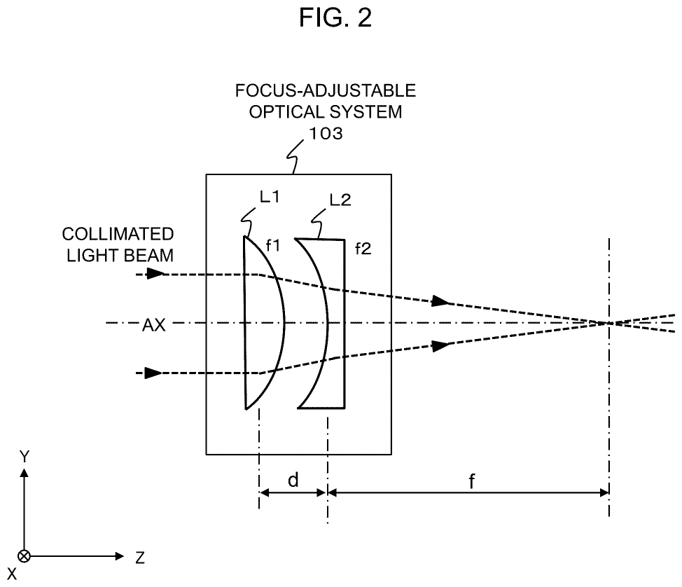

As illustrated in FIG. 2, the focus-adjustable optical system 103 can be composed of a combination of a convex lens L1 and a concave lens L2. It is assumed that the convex lens L1 and the concave lens L2 are arranged apart by a distance d in the direction of the optical axis AX (Z direction), wherein the distance d can be varied.

Assuming that the focal lengths of the convex lens L1 and the concave lens L2 are denoted as f1 and f2, respectively, the combined focal length f of the focus-adjustable optical system 103 is represented by

$$f = f 1 \times f 2 / ( f 1 + f 2 - d ) .$$

Accordingly, the combined focal length f can be moved along the optical axis AX (Z-axis) by adjusting the distance d between the convex lens L1 and the concave lens L2. Also, the optical axis AX can be shifted in the X-axis direction and/or the Y-axis direction by moving the focus-adjustable optical system 103 along the X-Y plane.

As described above, the wavelength λg of the guide light L_{G} is shorter than the wavelength λs of the signal light L_{S}. Accordingly, the focal length f(λg) of the focus-adjustable optical system 103 when the guide light L_{G} passes through is shorter than the focal length f(λs) of the focus-adjustable optical system 103 when the signal light L_{S} passes through. Instead of the combination of the convex lens L1 and the concave lens L2, the focus-adjustable optical system 103 may use a liquid lens whose focal length can be changed.

### <Predetermined Pattern>

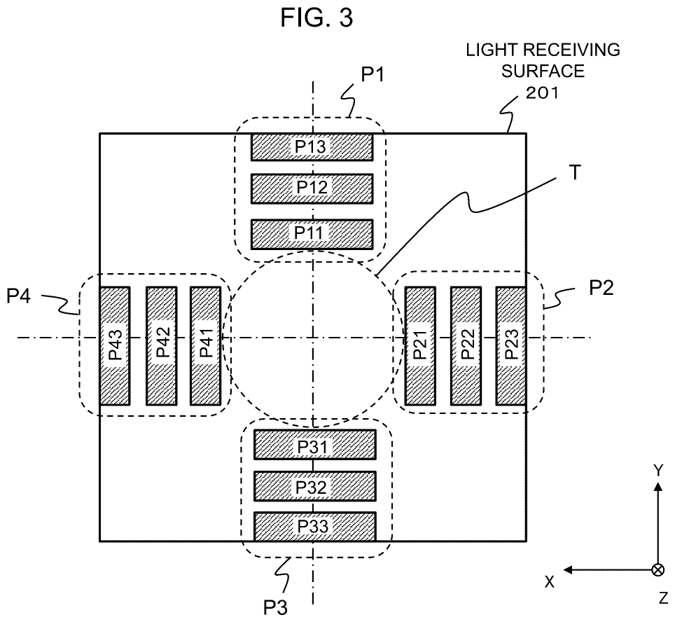

As illustrated in FIG. 3, the predetermined pattern provided on the light receiving surface 201 of the receiver 200 includes pattern sections P2 and P4 in the X-axis direction and pattern sections P1 and P3 in the Y-axis direction, centered around the light reception area T. In each pattern section, multiple reflective areas having a spacing are arranged radially around the light reception area T. More specifically, in the pattern section P1, a reflective area P11 is positioned closest to the light reception area T, and reflective areas P12 and P13 are arranged at predetermined intervals in the direction moving away from the light reception area T. Similarly, in the pattern section P2, reflective areas P21, P22, and P23 are arranged at predetermined intervals in the direction away from the light reception area T. In the pattern section P3, reflective areas P31, P32, and P33 are arranged at predetermined intervals in the direction away from the light reception area T. In the pattern section P4, reflective areas P41, P42, and P43 are arranged at predetermined intervals in the direction away from the light reception area T.

<Optimal illumination State>

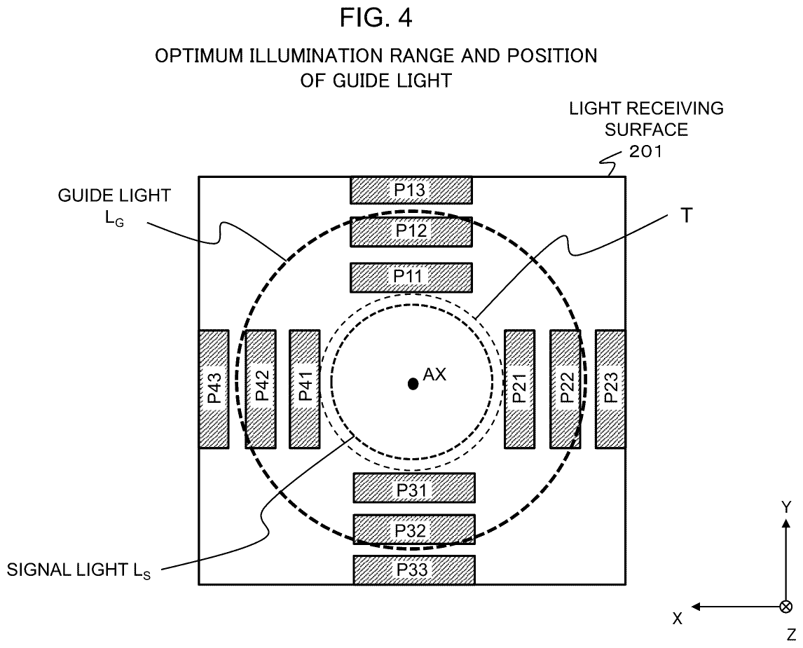

As illustrated in FIG. 4, it is assumed that, when the signal light L_{S} is directed to the light reception area T of the light receiving surface 201 in an optimum condition without excess or deficiency, reflective areas up to the second inner area of each pattern section are illuminated with the guide light L_{G} on the same optical axis AX as the signal light L_{S}. In other words, in the case where the signal light L_{S} is projected onto only the light reception area T, that is, the signal light L_{S} on the light receiving surface 201 having the beam diameter substantially equal to the diameter of the light reception area T, the guide light L_{G} is projected onto the reflective areas P21, P22, P41, and P42 in the X-axis direction and the reflective areas P11, P12, P31, and P32 in the Y-axis direction.

In such an optimum illumination state, the signal light L_{S} and the guide light L_{G} on the same optical axis AX are focused at reference focus positions (beam waists) between the transmitter 100 and the receiver 200, respectively, thereby properly illuminating the light receiving surface 201.

In reference to the optimum illumination state, when the beam diameter of the guide light L_{G} deviates from the reference, the illuminated reflective areas by the guide light L_{G} changes in the X-axis and Y-axis directions. Accordingly, it is possible to detect the presence or absence of focus deviation for the signal light L_{S} and the amount of the focus deviation by the camera 104 capturing a pattern of reflective areas illuminated with the guide light L_{G}, that is, a partial pattern of the predetermined pattern.

When the optical axis AX of the guide light L_{G} deviates from the reference, the range of reflective areas illuminated by the guide light L_{G} is shifted in the X-axis and/or Y-axis directions. Accordingly, it is possible to detect the presence or absence of optical-axis deviation of the signal light L_{S} and the amount of the optical-axis deviation by the camera 104 capturing a partial pattern of reflective areas illuminated with the guide light L_{G}.

In the example as shown in FIG. 4, each pattern section includes, but not limited to, three reflective areas arranged therein. It is possible to measure the amount of focus deviation and optical-axis deviation of the signal light L_{S} with a desired level of granularity depending on the number of reflective areas, the width of each reflective area and the spacing between reflective areas in a radiation direction. The optical adjustment controller 110 measures the amount of focus deviation and optical-axis deviation to adjust the focus position and optical axis position of the focus-adjustable optical system 103 to eliminate these deviations.

According to the present example embodiment, pattern recognition can be used for rapid optical adjustments, namely focus adjustment and optical-axis adjustment. Furthermore, the guide light L_{G} that has the same optical axis as the signal light L_{S} but a different wavelength can be used to illuminate a wide area of the light receiving surface 201 with the guide light due to the difference in refractive index. Accordingly, without using a special optical system for the guide light, rapid and high-precision optical adjustments can be achieved with a simple configuration.

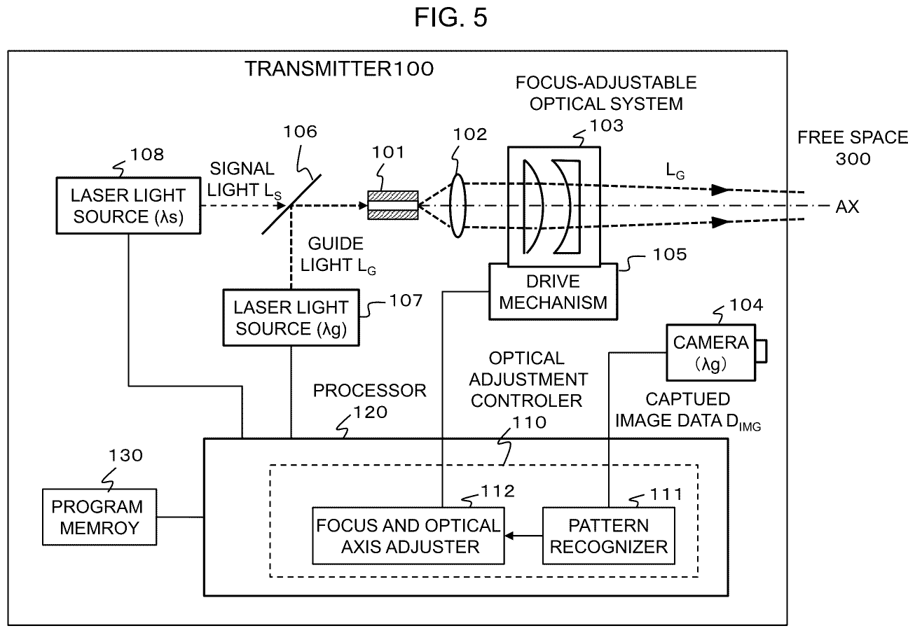

Hereinafter, the configuration and operation of an optical adjustment device according to an example of the present invention will be described in detail with reference to FIGS. 5 to 9. However, the components similar to those in the above-described example embodiment (FIG. 1) are denoted by the same reference numerals, and their descriptions will be simplified.

### 2. Example

### 2.1) Configuration

As illustrated in FIG. 5, the transmitter 100 includes, as described above, the optical fiber 101, collimator 102, focus-adjustable optical system 103, and camera 104. The focus-adjustable optical system 103 has the lens configuration as illustrated in FIG. 2. A drive mechanism 105 can move the combined focal length f of the focus-adjustable optical system 103 along the Z-axis, and the optical axis AX in the X-axis and/or Y-axis directions. For example, the drive mechanism 105 may include a first moving mechanism that changes the distance d between lens holders each holding the convex lens L1 and the concave lens L2, and a second moving mechanism that moves the entire focus-adjustable optical system 103 in the X-axis direction and/or the Y-axis direction.

Furthermore, the transmitter 100 includes a laser light source 107 that outputs guide light L_{G} of wavelength λg, a laser light source 108 that outputs signal light L_{S} of infrared wavelength λs, and a dichroic mirror 106. In this example, the wavelength λg of the guide light L_{G} is 650 nm, and the wavelength λs of the signal light L_{S} is 1550 nm.

The dichroic mirror 106 has the characteristic of reflecting the guide light L_{G} of wavelength λg and transmitting the signal light L_{S} of wavelength λs. The guide light L_{G} of wavelength λg is reflected by the dichroic mirror 106 to enter the optical fiber 101, while the signal light L_{S} of wavelength λs passes through the dichroic mirror 106 to enter the optical fiber 101. The laser light sources 107 and 108 and the dichroic mirror 106 are arranged so that the guide light L_{G} and signal light L_{S} incident on the optical fiber 101 have the same optical axis.

Furthermore, the transmitter 100 includes a processor 120 and a program memory 130. The processor 120 can implement the functions of the optical adjustment controller 110 described above by executing programs stored in the program memory 130.

The optical adjustment controller 110 has the functions of a pattern recognizer 111 and a focus and optical-axis adjuster 112. The pattern recognizer 111 receives image data D_{IMG} captured by the camera 104 and extracts a partial pattern of the reflective areas illuminated by the guide light L_{G} from the image data D_{IMG}. Furthermore, the pattern recognizer 111 executes pattern matching between the partial pattern and the predetermined pattern previously stored to recognize which part of the predetermined pattern the partial pattern matches.

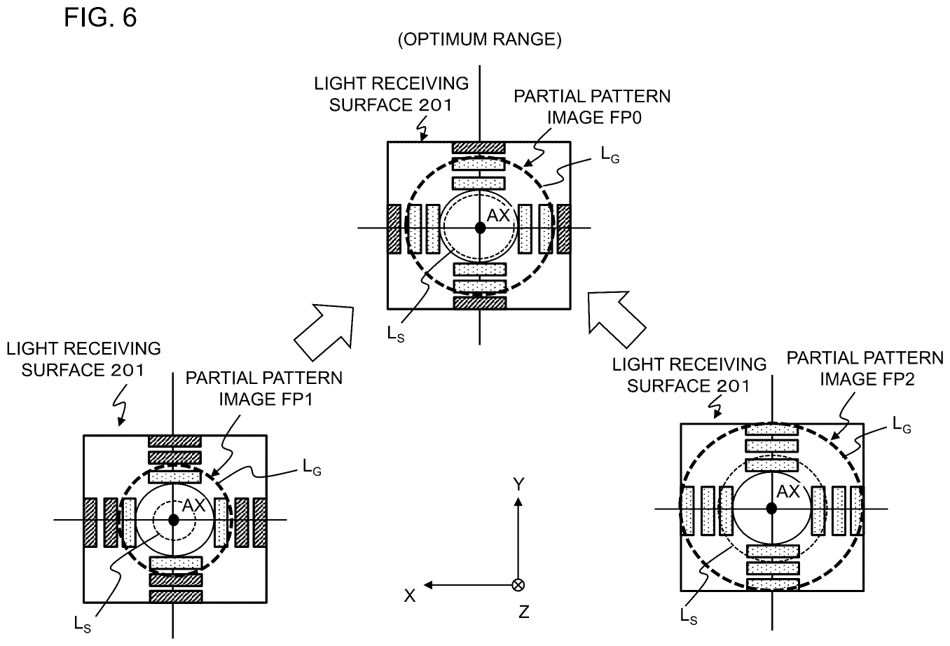

The focus and optical-axis adjuster 112 adjusts the focus position and/or optical axis of the focus-adjustable optical system 103 using the drive mechanism 105 so that the partial pattern matches a pattern within a predetermined range at the center of the predetermined pattern (see FIG. 4), based on recognition result obtained by the pattern recognizer 111. As described above, moving the focus position in the Z-axis direction can adjust the diameter of illumination beam by the guide light L_{G} on the light receiving surface 201. Moving the optical axis of the focus-adjustable optical system 103 along the X-Y plane can adjust the position of the optical axis of illumination beam by the guide light L_{G} on the light receiving surface 201. In this manner, adjustment using the guide light L_{G} can adjust the signal light L_{S} of the same optical axis. Next, referring to FIGS. 6 to 8, an example of the optical adjustment method according to the present example will be described.

### 2.2) Operation

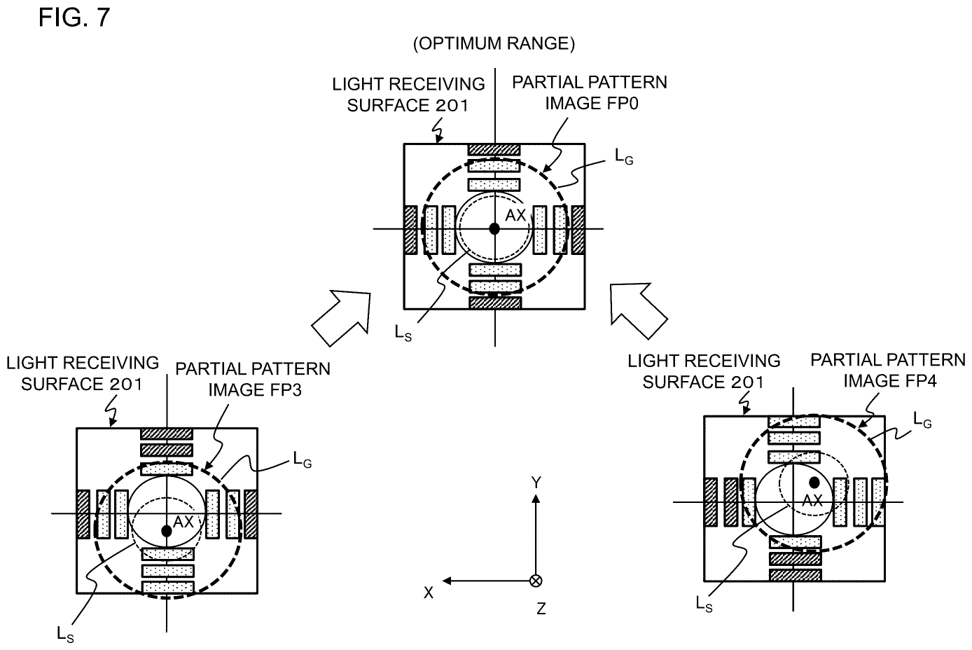

First, as illustrated in FIGS. 6 and 7, when the focus position of the focus-adjustable optical system 103 is at the optimum position, the guide light L_{G} illuminates reflective areas P11-P12, P21-P22, P31-P32, and P41-P42 of the predetermined pattern (see FIG. 4). In this case, it is assumed that the partial pattern obtained from the image data captured by the camera 104 is a partial pattern image FP0.

### <Focal Position Adjustment>

Referring to FIG. 6, when the focus position of the focus-adjustable optical system 103 deviates toward the receiver 200 from the optimum position, a narrower range than the optimum range on the predetermined pattern of the light receiving surface 201 is illuminated with the guide light L_{G}. Here, the narrower range includes the reflective areas P11, P21, P31, and P41 of the predetermined pattern. In this case, the partial pattern obtained from the image data captured by the camera 104 is the partial pattern image FP1.

Conversely, when the focus position of the focus-adjustable optical system 103 deviates toward the transmitter 100 from the optimum position, a wider range than the optimum range including the predetermined pattern on the light receiving surface 201 is illuminated with the guide light L_{G}. Here, the wider range includes the reflective areas P11-P13, P21-P23, P31-P33, and P41-P43 of the predetermined pattern. In this case, the partial pattern obtained from the image data captured by the camera 104 is the partial pattern image FP2.

In this way, the amount of focus position deviation of the focus-adjustable optical system 103 can be estimated depending on which reflective areas of the predetermined pattern the partial pattern image includes. The focus and optical-axis adjuster 112 shifts the focus position of the focus-adjustable optical system 103 along the Z-axis direction to eliminate the amount of deviation of the focus position.

### <Optical Axis Position Adjustment>

Referring to FIG. 7, when the optical axis of the focus-adjustable optical system 103 deviates from the optimum position in the Y-axis direction of the light receiving surface 201, a range of the predetermined pattern on the light receiving surface 201 illuminated with the guide light L_{G} is shifted in the negative Y-axis direction from the optimum range. Here, the reflective areas P11, P21-P22, P31-P33, and P41-P42 of the predetermined pattern are illuminated with the guide light L_{G}. In this case, the partial pattern obtained from the image data captured by the camera 104 is the partial pattern image FP3.

When the optical axis of the focus-adjustable optical system 103 deviates from the optimum position in the X-axis and Y-axis directions of the light receiving surface 201, a range of the predetermined pattern on the light receiving surface 201 illuminated by the guide light L_{G} is shifted in the negative X-axis direction and positive Y-axis direction beyond the optimum range. Here, the reflective areas P11-P13, P21-P23, P31, and P41 of the predetermined pattern are illuminated with the guide light L_{G}. In this case, the partial pattern obtained from the image data captured by the camera 104 is the partial pattern image FP4.

Pattern recognition of the image of the partial pattern thus obtained can be used to determine which part of the prescribed pattern the captured partial pattern matches, thereby estimating the amount of deviation of the optical axis AX of the focus-adjustable optical system 103. The focus and optical axis adjuster 112 moves the focus-adjustable optical system 103 in X-axis and/or Y-axis direction to eliminate the deviation of the optical axis.

### <Optical Adjustment>

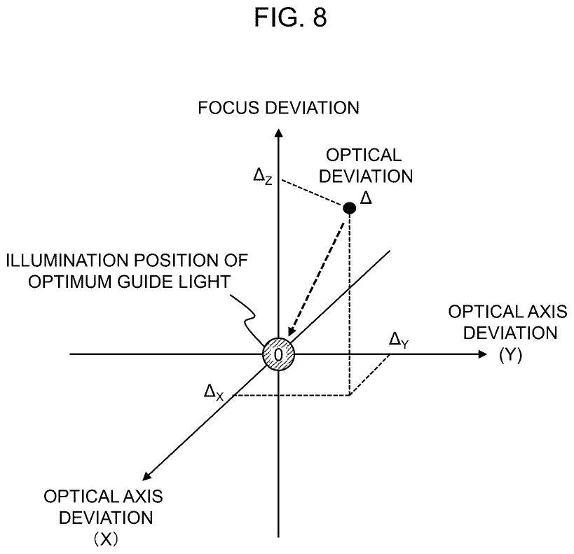

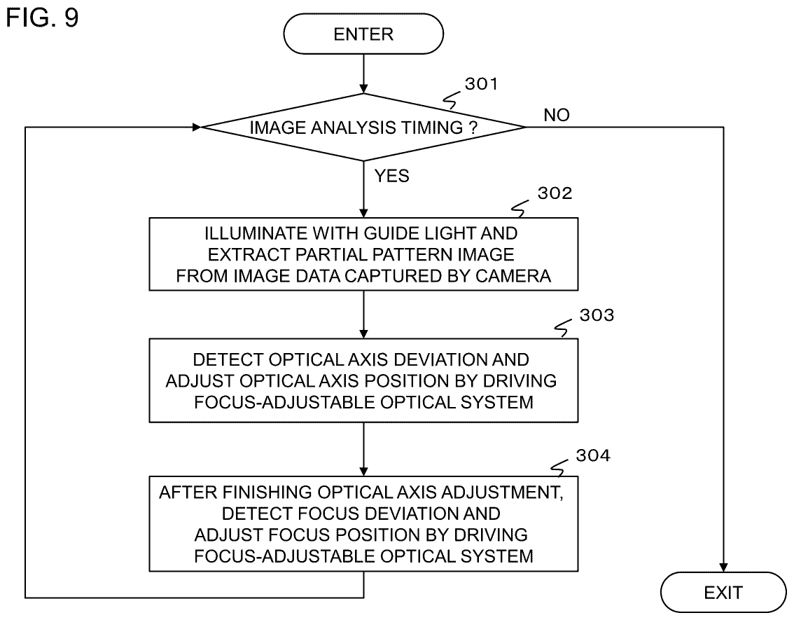

At least one of the above-described focus position adjustment and optical axis adjustment is performed, allowing the guide light L_{G} to direct to a predetermined position and range of the predetermined pattern on the light receiving surface 201. As a result, the light reception area T of the light receiving surface 201 can be optimally illuminated with the signal light L_{S} having the same optical axis as the guide light L_{G}. Hereinafter, the optical adjustment operation according to the present example will be described with reference to FIGS. 8 and 9.

As illustrated in FIG. 8, let us assume that an optical axis deviation Δx in X-axis direction, an optical axis deviation Δy in Y-axis direction, and a focus deviation Δz have occurred. According to the present example, an optical deviation Δ detected by the guide light L_{G} can be eliminated, allowing the guide light to be optically adjusted to the optimum illumination position (substantially zero deviation).

Referring to FIG. 9, the processor 120 determines whether it is the timing for image analysis (operation 301). If it is the image analysis timing (YES in operation 301), the processor 120 drives the laser light source 107 to emit the guide light L_{G}. Next, the processor 120 drives the camera 104 to capture an image of the light receiving surface illuminated by the guide light L_{G} and obtains a partial pattern image from the captured image data (operation 302).

Next, the processor 120 determines, by pattern matching, which part of the predetermined pattern matches the partial pattern of the captured partial pattern image, thereby detecting the amount of deviation (Δx, Δy) of the optical axis AX of the variable-focus optical system 103. Then, the processor 120 controls the drive mechanism 105 to drive the focus-adjustable optical system 103 to adjust the position of the optical axis AX so that the deviation amount (Δx, Δy) is canceled (operation 303).

After the optical axis adjustment is completed, the processor 120 detects the amount of focus position deviation Δz depending on which reflective areas of the predetermined pattern are included in the captured partial pattern image. Next, the processor 120 controls the drive mechanism 105 to drive the focus-adjustable optical system 103 to adjust the focus position of the focus-adjustable optical system 103 so that the deviation amount Δz is canceled (operation 304).

In this manner, pattern recognition allows high-speed optical axis adjustment and focus adjustment. Furthermore, the guide light L_{G} has the wavelength different from that of the signal light L_{S}, but the same optical axis as the signal light L_{S}. Accordingly, a wide area of the light receiving surface 201 can be illuminated with the guide light L_{G} due to difference in refractive index. Therefore, without using a special optical system for the guide light, rapid and high-accurate optical adjustment can be achieved with a simple configuration.

The operations 302 to 304 described above are repeated at each image analysis timing, but they are not executed when it is not the image analysis timing (NO in operation 301). In addition, the processor 120 may adjust the focus-adjustable optical system 103 to eliminate the amount of deviation, thereafter re-execute the operations 302 to 304 to confirm whether the amount of deviation has been sufficiently reduced. If the amount of deviation exceeds a predetermined threshold, adjustment operations of operation 303 and/or operation 304 may be repeated.

The image analysis timing in operation 301 may be set appropriately depending on an optical system to which the optical axis adjustment according to the present example embodiment is applied. For example, in an optical communication system using quantum light, it is necessary to perform accurate alignment of a signal light beam between the transmitter and the receiver. Also, when the amount of light incident on the receiving side fluctuates due to vibration of the communication device, the focus and optical axis can be adjusted in almost real-time by shortening the interval of the image analysis timing.

### 3. Application

Hereinafter, an application of the optical adjustment device according to the above-described example to a quantum key distribution (QKD) system will be described. Blocks similar to those of the transmitter 100 illustrated in FIG. 5 are denoted by the same reference numerals, and their descriptions are omitted.

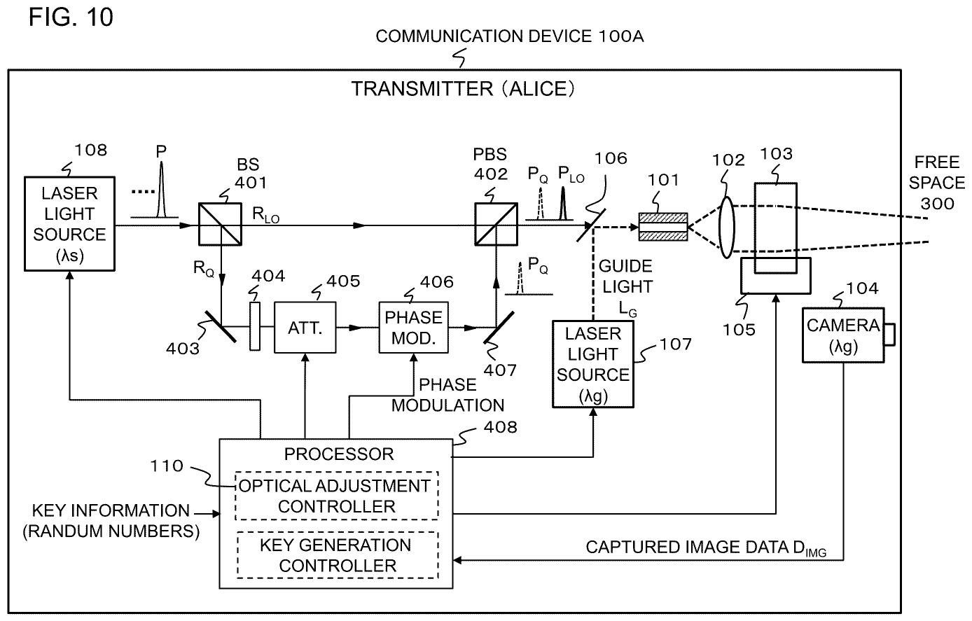

As illustrated in FIG. 10, a quantum cryptography communication system includes a communication device 100A including a transmitter (Alice) and a communication device (not shown) including a receiver (Bob). The communication device 100A has the functions of the transmitter 100 as illustrated in FIG. 5.

Furthermore, the communication device 100A includes a non-polarizing beam splitter (BS) 401, a polarizing beam splitter (PBS) 402, a mirror 403, a half-wave plate 404, an attenuator 405, a phase modulator 406, a mirror 407, and at least one processor 408. Here, the input port of the non-polarizing beam splitter 401 is optically connected to the output port of the laser light source 108, and the output port of the polarizing beam splitter 402 is optically connected to the optical fiber 101 through the dichroic mirror 106.

The laser light source 108 of the communication device 100A outputs linearly polarized light pulses P of wavelength λs to the input port of the non-polarizing beam splitter 401. Each of the light pulses P is split by the non-polarizing beam splitter 401 into one light pulse sent to a reference-side route R_{LO} for reference light and the other pulse light pulse sent to a signal-side route R_{Q} for signal light.

The one light pulse on the reference-side route R_{LO} passes through the polarizing beam splitter 402 as it is, passes through the dichroic mirror 106 as a reference light pulse P_{LO} of normal intensity having no quantum state, and enters the optical fiber 101. The other light pulse on the signal-side route R_{Q} enters the polarizing beam splitter 402 through the mirror 403, half-wave plate 404, attenuator 405, phase modulator 406, and mirror 407 and is reflected by the polarizing beam splitter 402 to the dichroic mirror 106 as a very weak signal light pulse P_{Q} having quantum states. The very weak signal light pulse P_{Q} passes through the dichroic mirror 106 and enters the optical fiber 101. More specifically, the half-wave plate 404 rotates the plane of polarization of the light pulse on the signal-side route R_{Q} by 90 degrees. The attenuator 405 attenuates the light pulse to a very weak light pulse having quantum states. The phase modulator 406 performs phase modulation on the very weak light pulse to generate the signal light pulse P_{Q}. The attenuator 405 and the phase modulator 406 may be arranged in the reverse order with respect to the traveling direction of the light pulse.

Here, the signal-side route R_{Q} has an optical path length longer than the reference-side route R_{LO}. Due to the difference in optical path length between the signal-side route R_{Q} and the reference-side route R_{LO}, the signal light pulse P_{Q} and the reference light pulse P_{LO} generated from a single light pulse P are temporally separated. By the signal light pulse P_{Q} traveling through the half-wave plate 404, the non-polarizing beam splitter 401 and the polarizing beam splitter 402, the respective planes of polarization of the signal light pulse P_{Q} and the reference light pulse P_{LO} are orthogonal to each other. In this way, the signal light pulse P_{Q} and the reference light pulse P_{LO} are transmitted as the signal light L_{S} as described above. It should be noted that, if the non-polarizing beam splitter 401 is replaced by a polarizing beam splitter, the half-wave plate 404 may not be necessary.

The processor 408 controls the communication device 100A and, in addition to the key generation controller for generating encryption keys, also has the functions of the optical adjustment controller 110 as described above. Specifically, the processor 408 first uses the guide light L_{G} to perform the above-described optical axis and focus position adjustment (optical adjustment) of the focus-adjustable optical system 103 before performing key generation.

Once the optical adjustment is completed, the processor 408 controls the laser light source 108, the attenuator 405, and the phase modulator 406. The phase modulator 406 is driven at four phases (0°, 90°, 180°, 270°) according to source random numbers for a cryptographic key. The phase modulator 406 thus driven performs phase modulation on each very weak light pulse output from the attenuator 405 according to key information to generate the signal light pulse P_{Q} by phase modulation. In this manner, a pulse sequence of two consecutive pulses consisting of a reference light pulse P_{LO} of normal intensity and a phase-modulated signal light pulse P_{Q} travels through the dichroic mirror 106, optical fiber 101, collimator 102, and focus-adjustable optical system 103 and is directed as the signal light L_{S} onto the light receiving surface 201 of the receiver (Bob). Since the focus-adjustable optical system 103 has been optically adjusted using the guide light L_{G} as described above, the reference light pulse P_{LO} and the signal light pulse P_{Q} (signal light L_{S}) having the same optical axis as the guide light L_{G} accurately enter the light reception area T of the receiver 200.

The receiver 200 is equipped with an interferometer that interferes a reference light pulse P_{LO} and a received signal light pulse P_{Q} received from the transmitter through the free space 300, and detects a transmitted signal by homodyne detection. However, since this is not the essence of the present invention, the explanation is omitted. In the QKD system through free-space optical transmission, the very weak signal light having quantum states is transmitted through the free space 300. Accordingly, it is especially important to accurately direct the signal light Ls to the light reception area T of the receiver 200. The optical adjustment device according to the example embodiment can be applied to construct a highly reliable QKD system.

### 4. Additional Statements

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with other embodiments. Part or all of the above-described illustrative embodiments can also be described as, but are not limited to, the following additional statements.

### Additional Statement 1

An optical adjustment device in a free-space optical communication system in which signal light is transmitted from a transmitter to a receiver, comprising:
a focus-adjustable optical system configured to focus guide light into a focus position between the transmitter and the receiver to illuminate a range wider than a light reception area of the receiver with the guide light, wherein the guide light and the signal light have a common optical axis;
an image capturing unit that captures an image of a partial pattern of a predetermined pattern provided around the light reception area, wherein the partial pattern is illuminated by the guide light; and
a controller configured to adjust at least one of the focus position and optical axis of the focus-adjustable optical system so that the partial pattern illuminated matches a predetermined part of the predetermined pattern.

### Additional Statement 2

The optical adjustment device according to additional statement 1, wherein the focus-adjustable optical system includes a lens system including a plurality of refractive surfaces, wherein the focus position for the guide light differs from that for the signal light.

### Additional Statement 3

The optical adjustment device according to additional statement 2, wherein the wavelength of the guide light is shorter than the wavelength of the signal light.

### Additional Statement 4

The optical adjustment device according to additional statement 2, wherein a refractive index for the guide light is greater than that for the signal light.

### Additional Statement 5

The optical adjustment device according to any one of additional statements 1-4, wherein the predetermined pattern includes a plurality of reflective areas spreading radially around the light reception area.

### Additional Statement 6

The optical adjustment device according to additional statement 5, wherein the plurality of reflective areas are arranged at predetermined intervals along two orthogonal axes centered on the light reception area.

### Additional Statement 7

The optical adjustment device according to additional statement 5 or 6, wherein the plurality of reflective areas is made of a retroreflective material.

### Additional Statement 8

The optical adjustment device according to any one of additional statements 5-7, wherein the image capturing unit selectively captures reflected light of a wavelength of the guide light.

### Additional Statement 9

An optical adjustment method in a free-space optical communication system in which signal light is transmitted from a transmitter to a receiver, comprising:
preparing a predetermined pattern around a light reception area in the receiver;
by a focus-adjustable optical system, focusing guide light into a focus position between the transmitter and the receiver to illuminate a range wider than a light reception area of the receiver with the guide light, wherein the guide light and the signal light have a common optical axis;
by an image capturing unit, capturing an image of a partial pattern of the predetermined pattern, wherein the partial pattern is illuminated by the guide light; and
by a controller, adjusting at least one of the focus position and optical axis of the focus-adjustable optical system so that the partial pattern illuminated matches a predetermined part of the predetermined pattern.

### Additional statement 10

The optical adjustment method according to additional statement 9, wherein the focus-adjustable optical system includes a lens system including a plurality of refractive surfaces, wherein the focus position for the guide light differs from that for the signal light.

### Additional Statement 11

The optical adjustment method according to additional statement 10, wherein the wavelength of the guide light is shorter than the wavelength of the signal light.

### Additional Statement 12

The optical adjustment method according to additional statement 10, wherein a refractive index for the guide light is greater than that for the signal light.

### Additional Statement 13

The optical adjustment method according to any one of additional statements 9-12, wherein the predetermined pattern includes a plurality of reflective areas spreading radially around the light reception area.

### Additional Statement 14

The optical adjustment method according to additional statement 13, wherein the plurality of reflective areas are arranged at predetermined intervals along two orthogonal axes centered on the light reception area.

### Additional Statement 15

The optical adjustment method according to additional statement 13 or 14, wherein the plurality of reflective areas is made of a retroreflective material.

### Additional Statement 16

The optical adjustment method according to any one of additional statements 13-15, wherein the image capturing unit selectively captures reflected light of a wavelength of the guide light.

### Additional Statement 17

A transmitter including the optical adjustment device according to any one of additional statements 1-8, wherein the controller adjusts at least one of the focus position and optical axis of the focus-adjustable optical system using the guide light before performing free-space optical communication using the signal light.

### Additional Statement 18

The transmitter according to additional statement 17, wherein the free-space optical communication system is a quantum key distribution system, wherein the signal light includes a very weak light having quantum states.

### Additional Statement 19

A program functioning a computer as an optical adjustment device in a free-space optical communication system in which signal light is transmitted from a transmitter to a receiver, wherein the optical adjustment device includes: a focus-adjustable optical system configured to focus guide light into a focus position between the transmitter and the receiver to illuminate a range wider than a light reception area of the receiver with the guide light, wherein the guide light and the signal light have a common optical axis; and an image capturing unit that captures an image of a partial pattern of a predetermined pattern provided around the light reception area, wherein the partial pattern is illuminated by the guide light,
the program comprising:
a function of: recognizing the partial pattern from captured data by the image capturing unit by illuminating with the guide light; and performing pattern matching of the partial pattern and the predetermined pattern; and
a function of adjusting at least one of the focus position and optical axis of the focus-adjustable optical system so that the partial pattern illuminated matches a predetermined part of the predetermined pattern.

The present invention can be applied to communication devices in optical communication systems that require optical adjustment.

### DESCRIPTION OF REFERENCE NUMERALS

100 Transmitter
101 Optical fiber
102 Collimator
103 Focus-adjustable optical system
104 Camera
105 Drive mechanism
106 Dichroic mirror
107 Laser light source (wavelength λg)
108 Laser light source (wavelength λs)
110 Optical adjustment controller
111 Pattern recognizer
112 Focus and optical axis adjuster
120 Processor
130 Program memory
200 Receiver
201 Light receiving surface
202 Collimator
203 Optical fiber
L_{G} Guide light
L_{S} Signal light
T Light reception area
P1-P4 Predetermined pattern
FP0-FP4 Partial pattern image
300 Free space

1. An optical communication device that transmits signal light to another optical communication device in a free-space optical communication system, comprising:
an image capturing unit that captures an image including a predetermined pattern provided on a light receiving surface of the another optical communication device, wherein the predetermined pattern is provided around a light reception area which is a target area for the signal light;
a focus-adjustable optical system configured to focus a light beam into a desired focus position between the optical communication device and the another optical communication device, wherein the light beam is one of guide light and the signal light which have a common optical axis; and
a controller configured to:
emit the guide light to the another optical communication device through the focus-adjustable optical system to illuminate a range wider than the light reception area with the guide light;
extract a partial pattern of the predetermined pattern illuminated with the guide light from the image captured by the image capturing unit; and
adjust at least one of the focus position and optical axis of the focus-adjustable optical system so that the partial pattern matches a predetermined part of the predetermined pattern causing the light reception area to be optimally illuminated with the signal light.

2. The optical communication device according to claim 1, wherein the focus-adjustable optical system includes a lens system including a plurality of refractive surfaces, wherein a first focus position for the guide light is closer to the optical communication device than a second focus position for the signal light.

3. The optical communication device according to claim 2, wherein the wavelength of the guide light is shorter than the wavelength of the signal light.

4. The optical communication device according to claim 2, wherein a refractive index for the guide light is greater than that for the signal light.

5. The optical communication device according to claim 1, wherein the predetermined pattern includes a plurality of reflective areas spreading radially around the light reception area.

6. The optical communication device according to claim 5, wherein the plurality of reflective areas are arranged at predetermined intervals along two orthogonal axes centered on the light reception area.

7. The optical communication device according to claim 5, wherein the plurality of reflective areas is made of a retroreflective material.

8. The optical communication device according to claim 5, wherein the image capturing unit selectively captures reflected light of a wavelength of the guide light.

9. An optical adjustment method in a free-space optical communication system in which signal light is transmitted from a transmitter to a receiver, comprising:
preparing a light receiving surface provided at the receiver, including a light reception area which is a target area for the signal light and a predetermined pattern provided around the light reception area;
by a focus-adjustable optical system, focusing a light beam into a desired focus position between the transmitter and the receiver, wherein the light beam is one of guide light and the signal light which have a common optical axis;
by a controller,
emitting the guide light to the receiver through the focus-adjustable optical system to illuminate a range wider than the light reception area with the guide light;
extracting a partial pattern of the predetermined pattern illuminated with the guide light from the image captured by an image capturing unit; and
adjusting at least one of the focus position and optical axis of the focus-adjustable optical system so that the partial pattern matches a predetermined part of the predetermined pattern causing the light reception area to be optimally illuminated with the signal light.

10. The optical adjustment method according to claim 9, wherein the focus-adjustable optical system includes a lens system including a plurality of refractive surfaces, wherein a first focus position for the guide light is closer to the transmitter than a second focus position for the signal light.

11. The optical adjustment method according to claim 10, wherein the wavelength of the guide light is shorter than the wavelength of the signal light.

12. The optical adjustment method according to claim 10, wherein a refractive index for the guide light is greater than that for the signal light.

13. The optical adjustment method according to claim 9, wherein the predetermined pattern includes a plurality of reflective areas spreading radially around the light reception area.

14. The optical adjustment method according to claim 13, wherein the plurality of reflective areas are arranged at predetermined intervals along two orthogonal axes centered on the light reception area.

15. The optical adjustment method according to claim 13, wherein the plurality of reflective areas is made of a retroreflective material.

16. The optical adjustment method according to claim 13, wherein the image capturing unit selectively captures reflected light of a wavelength of the guide light.

17. A transmitter including the optical communication device according to claim 1, wherein the controller directs the guide light to the light receiving surface and adjusts at least one of the focus position and optical axis of the focus-adjustable optical system before directing the signal light to the light reception area to perform the free-space optical communication.

18. The transmitter according to claim 17, wherein the free-space optical communication system is a quantum key distribution system, wherein the signal light includes a very weak light having quantum states.

19. A non-transitory recording medium storing a computer-readable program for a transmitter in a free-space optical communication system in which signal light is transmitted from the transmitter to a receiver, wherein the optical communication device includes: an image capturing unit that captures an image including a predetermined pattern provided on a light receiving surface of the receiver, wherein the predetermined pattern is provided around a light reception area which is a target area for the signal light; and a focus-adjustable optical system configured to focus a light beam into a desired focus position between the transmitter and the receiver, wherein the light beam is one of guide light and the signal light which have a common optical axis;
the program comprising instructions to:
emit the guide light from a guide light source to the receiver through the focus-adjustable optical system to illuminate a range wider than the light reception area with the guide light;
extract a partial pattern of the predetermined pattern illuminated with the guide light from the image captured by the image capturing unit;
perform pattern matching of the partial pattern and the predetermined pattern; and
adjust at least one of the focus position and optical axis of the focus-adjustable optical system so that the partial pattern illuminated matches a predetermined part of the predetermined pattern causing the light reception area to be optimally illuminated with the signal light.
